(19) United States
(12) Patent Application Publication
(10) Pub. No.: US 2015/0091825 A1
(43) Pub. Date: Apr. 2, 2015

(54) ELECTRONIC DEVICE AND SCREEN RESOLUTION ADJUSTMENT METHOD THEREOF

(71) Applicant: PEGATRON CORPORATION, Taipei City (TW)

(72) Inventor: Chao-Yen WU, Taipei City (TW)

(21) Appl. No.: 14/478,669

(22) Filed: Sep. 5, 2014

(30) Foreign Application Priority Data
Sep. 27, 2013 (TW) 102135198

(51) Int. Cl. G06F 3/041; G09G 5/391

(52) U.S. Cl. CPC G06F 3/0416; G06F 3/0412; G09G 5/391; G09G 2340/0407; G09G 2354/00
USPC 345/173

(57) ABSTRACT

A screen resolution adjustment method for a touch screen of an electronic device are disclosed, wherein the touch screen includes a central display region and an edge region. The screen resolution adjustment method includes the steps of: receiving a touch signal on the touch screen; judging whether the touch signal corresponds to a touch at the edge region; and if the touch signal corresponds to a touch at the edge region, adjusting the resolution of a displayed picture displayed at the touch screen of the electronic device to form a border frame around the central display region.

### BACKGROUND OF THE INVENTION

1. Field of Invention

The invention relates to a screen resolution adjustment method and, more particularly, to a screen resolution adjustment method for an electronic device having a touch screen, which method has the effect of creating a temporary virtual border frame.

2. Related Art

Tablet computers are widely welcomed by consumers due to their convenience and entertainment. In a general tablet computer, a border frame of about one inch is provided around the screen for the user to grip the tablet by hand and watch the contents shown on the screen. However, the border frame of the tablet computer occupies a certain volume, which may conflict with the need of a modern consumer for a smaller and more compact portable electronic device.

Therefore, there is a need for a novel tablet computer with a design of no border frame, and can adjust the resolution of the screen in view of the need of the user to form a virtual border frame temporarily.

### SUMMARY OF THE INVENTION

An objective of the invention is to provide a screen resolution adjustment method for an electronic device having a touch screen, which has the effect of forming a virtual border frame temporarily.

To achieve the above objective, the screen resolution adjustment method of the invention is for a touch screen of an electronic device, wherein the touch screen includes a central display region and an edge region. The screen resolution adjustment method includes the steps of: receiving a touch signal on the touch screen; judging whether the touch signal corresponds to a touch at the edge region; and if the touch signal corresponds to the touch at the edge region, adjusting the resolution of a displayed picture displayed at the touch screen of the electronic device to form a border frame around the central display region.

In one embodiment of the invention, the screen resolution adjustment method further includes the step of detecting a placed mode of the touch screen.

In one embodiment of the invention, the edge region includes a first edge region and a second edge region, and in the step of judging whether the touch signal corresponds to a touch at the edge region, it is judged whether the touch signal corresponds to the touch at the first edge region or the second edge region.

In one embodiment of the invention, if the touch signal corresponds to a touch at the edge region, in the step of adjusting the resolution of a displayed picture displayed at the touch screen of the electronic device to form a border frame around the central display region, the resolution of the displayed picture is adjusted to form the border frame according to the placed mode of the touch screen and the position of the touch signal.

In one embodiment of the invention, the screen resolution adjustment method further includes the steps of: judging whether the touch signal is lasted for more than a specific time period; and in the step of adjusting the resolution of a displayed picture displayed at the touch screen of the electronic device to form a border frame around the central display region, the resolution of the displayed picture is adjusted to form the border frame if the touch signal corresponds to a touch at the edge region and is lasted for more than the specific time period.

In one embodiment of the invention, the screen resolution adjustment method further includes the steps of: providing a function key region at the border frame; and removing the function key and the border frame and restoring the resolution of the displayed picture.

In one embodiment of the invention, the specific time period is between 1 to 3 seconds.

In one embodiment of the invention, a height of the edge region is between 1.5 to 2.5 centimeters.

Another objective of the invention is to provide an electronic device with a touch screen, which has the effect of forming a virtual border frame temporarily.

To achieve the above objective, the electronic device according to the invention includes a touch screen, a sensing module, a judgment module and a processing module. The touch screen includes a central display region and an edge region. The sensing module is for sensing a touch signal. The judgment module is for judging whether the touch signal corresponds to a touch at the edge region. The processing module is electronically connected with the touch screen, the sensing module and the judgment module. When the sensing module receives the touch module and the judgment module judges that the touch signal corresponds to the touch at the edge region, the processing module adjusts the resolution of a displayed picture displayed at the touch screen to form a border frame around the central display region.

In one embodiment of the invention, the judgment module also judges whether the touch signal is lasted for more than a specific time. If the judgment module judges that the touch signal corresponds to a touch at the edge region and is lasted for more than a specific time, the processing module adjusts the resolution of the displayed picture.

In one embodiment of the invention, the edge region includes a first edge region and a second edge region. The judgment module judges whether the touch signal corresponds to a touch at the first edge region or the second edge region, and the processing module adjusts the resolution of the displayed picture according to the judgment of the judgment module.

In one embodiment of the invention, when the sensing module receives the touch signal and the judgment module judges that the touch signal corresponds to a touch at the edge region, the processing modules controls the central display region to provide a function key region. The function key region is at the border frame.

### BRIEF DESCRIPTION OF THE DRAWINGS

FIG. 1 is a flowchart of the screen resolution adjustment method according to an embodiment of the invention.

FIG. 2 is a system architecture diagram of the electronic device according to an embodiment of the invention.

FIG. 3 is a schematic diagram of the electronic device according to an embodiment of the invention.

FIG. 4 is a schematic diagram of the electronic device which resolution is adjusted according to the touch signal corresponds to a touch at the first edge region according to an embodiment of the invention.

FIG. 5 is a schematic diagram of the electronic device which resolution is adjusted according to the touch signal corresponds to a touch at the second edge region according to an embodiment of the invention.

### DETAILED DESCRIPTION OF THE EMBODIMENT

The invention will become more fully understood from the detailed description and accompanying drawings, which are given for illustration only, and thus are not limitative of the present invention.

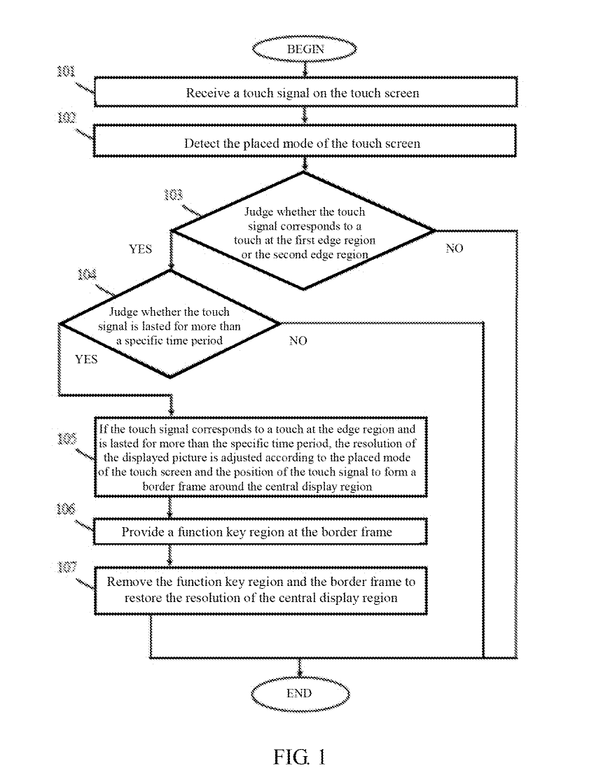

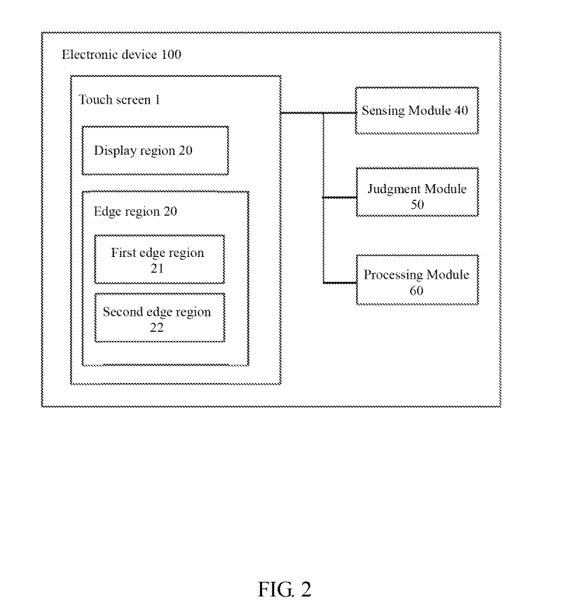

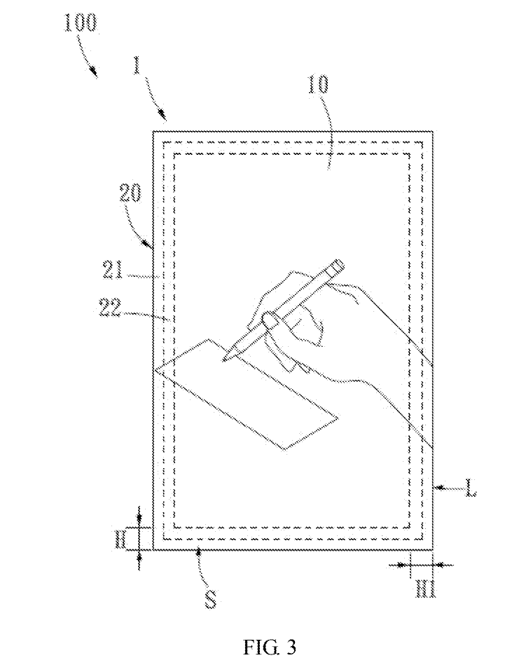

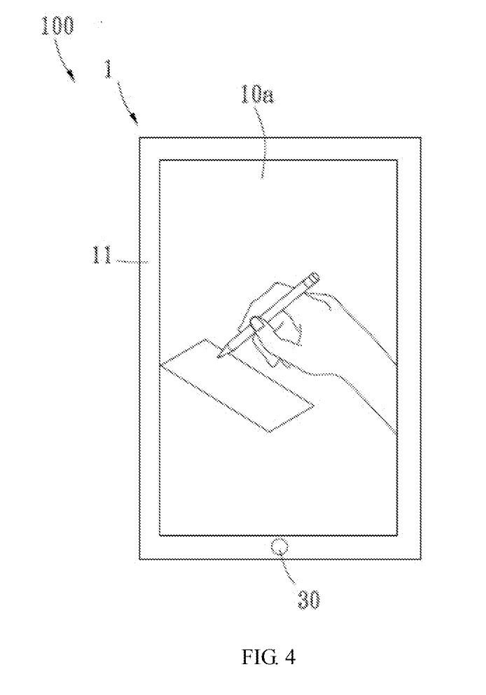

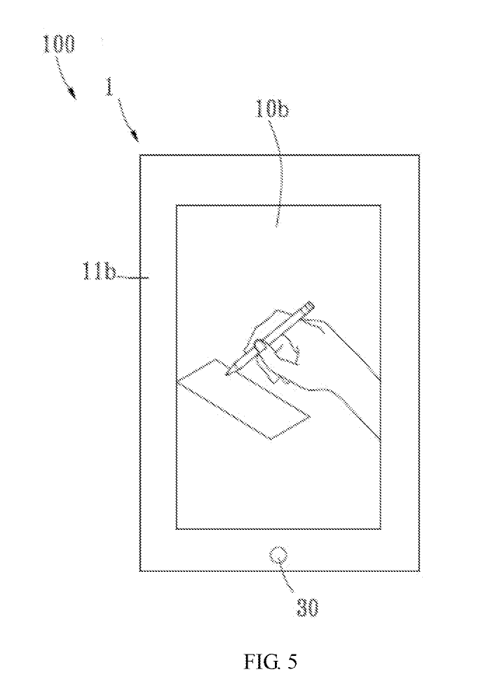

Please refer to FIG. 1 to FIG. 5. FIG. 1 is a flowchart of the screen resolution adjustment method according to an embodiment of the invention; FIG. 2 is a system architecture diagram of the electronic device according to an embodiment of the invention; FIG. 3 is a schematic diagram of the electronic device according to an embodiment of the invention; FIG. 4 is a schematic diagram of the electronic device which resolution is adjusted ; and FIG. 5 is a schematic diagram of the electronic device which resolution is adjusted according to the touch signal corresponds to a touch at the second edge region according to an embodiment of the invention.

As shown in FIG. 2 to FIG. 5, the screen resolution adjustment method according to an embodiment of the invention is implemented at an electronic device 100. The electronic device 100 is, for example, a 7-inch tablet computer with an aspect ratio of 4:3, that is, a tablet computer having a width of 10.688 centimeters and a length of 14.244 centimeters. However, the type of the electronic device 100 is not limited therein, and can be a smartphone or any other device with touch control functionalities. The size of the electronic device 100 is not limited therein, either, and can be a 10-inch tablet computer, or can have an aspect ratio of 16:9 or 16:10. The electronic device 100 includes a touch screen 1, a sensing module 40, a judgment module 50 and a processing module 60. The electronic device 100 may include a G-sensor or other components that have the function to detect the place mode of a device, which can actively detect whether the placed mode of the touch screen 1 of the electronic device 100 is vertically placed or horizontally placed.

The touch screen 1 does not have a physical border frame, and includes a central display region 10 and an edge region 20. The central display region 10 is for displaying a displayed picture 200 for the user to watch. Since the electronic device 100 of the embodiment does not have a border frame, the user can watch a full-screen picture of 10.688 cm×14.244 cm displayed by the central display region 10. The edge region 20 is provided around the central display region 10, and includes a long side L, a short side S, a first edge region 21 and a second edge region 22. The height H1 of the long side L is 2 cm, and the height H of the short side S is 2 cm. However, the height H1 of the long side L and the height H of the short side S are not limited therein and can be changed in view of different design requirements. The second edge region 22 is provided at the inner side of the first edge region 21.

The sensing module 40 is for receiving a touch signal and sending the touch signal to the judgment module 50. The judgment module 50 is for judging whether the touch signal corresponds to a touch at the first edge region 21 or the second edge region 22 of the edge region 20, and judging whether the touch signal is lasted for more than a specific time period. In the present embodiment, the specific time period is 2 seconds, but it is not limited therein and can be changed in view of practical needs. The processing module 60 is electrically connected with the touch screen 1, the sensing module 40 and the judgment module 50 for adjusting the resolution of the displayed picture 200 according to the judgment of the judgment module 50 and the placed mode of the touch screen 1 to form a border frame 11 around the central display region 10 and provide a function key region 30 at the position of the border frame 11.

Please refer to FIG. 1 to FIG. 4. First, step 101 is performed to receive a touch signal on the touch screen.

According to an embodiment of the invention, the user touches the touch screen 1 by a finger to generate the touch signal, and the sensing module 40 receives the touch signal.

Then, step 102 is performed to detect the placed mode of the touch screen.

According to one embodiment of the invention, the placed mode of the touch screen 1 is detected by the component of the electronic device 100 with the placed mode detection functionality (such as a G-sensor) to see whether the touch screen 1 is vertically placed or horizontally placed. The information of the placed mode is sent to the processing module 60. In the present embodiment, the placed mode of the touch screen 1 is vertically placed. Therefore, the information of a vertically placed mode is sent to the processing module 60.

Then, step 103 is performed to judge whether the touch signal corresponds to a touch at the first edge region or the second edge region.

As shown in FIG. 2, according to an embodiment of the invention, the sensing module 40 sends the touch signal to the judgment module 50. After receiving the touch signal, the judgment module 50 judges whether the touch signal corresponds to a touch at the first edge region 21 or the second edge region 22 of the edge region 20. If the touch signal is not corresponds to the touch at the edge region 20, the full-screen resolution of the displayed picture 200 is maintained. If the touch signal corresponds to a touch at the first edge region 21 or the second edge region 22 of the edge region 20, step 104 is performed.

Step 104 is performed to judge whether the touch signal is lasted for more than a specific time period.

According to an embodiment of the invention, the judgment module 50 judges whether the touch signal is lasted for more than a specific time period. The specific time period is 2 seconds in the present embodiment, but is not limited therein and can be changed in view of actual requirements. If the touch signal is not lasted for more than the specific time period of 2 seconds, than the full-screen resolution of the displayed picture is maintained. If the touch signal is lasted for more than the specific time period of 2 seconds, step 105 is performed.

Step 105 is performed as follow: if the touch signal corresponds to the touch at the edge region and is lasted for more than the specific time period, the resolution of the displayed picture displayed at the touch screen of the electronic device is adjusted according to the placed mode of the touch screen and the position of the touch signal to form a border frame around the central display region.

If the judgment module 50 judges that the touch signal corresponds to a touch at the first edge region 21 or the second edge region 22 of the edge region 20 and is lasted for more than the specific time period of 2 seconds, then the processing module 60 adjusts the resolution of the displayed picture according to the placed mode of the touch screen 1 detected at step 102 and the position of the touch signal at the first edge region 21 or the second edge region 22.

According to an embodiment of the invention, if the touch signal corresponds to the touch at the first edge region 21 as shown in FIG. 3, the processing module 60 reduces the resolution of the displayed picture 200 to 1680×1050 according to the vertical placed mode and the position of the touch signal as shown in

FIG. 4. By doing this, the area of the displayed picture 200a is reduced slightly, and a border frame 11 is formed around the central display region 10a for the user to hold the border frame 11 by hand to view the displayed picture 200a shown in the central display region 10a. If the position of the touch signal is at the second edge region 22 shown in FIG. 3, the processing module 60 reduces the resolution of the displayed picture 200 to 1440×900 according to the vertical placed mode and the position of the touch signal as shown in FIG. 5. By doing this, the area of the adjusted displayed picture 200b becomes even smaller, and a larger border frame 11b is formed around the central display region 10b. By touching different positions at the edge region 20, the user can adjust the resolution of the displayed picture 200 freely. However, the value of the adjusted resolution is not limited by the above embodiments, and can be changed in view of the size and the design requirements of the electronic device 100.

Next, step 106 is performed to provide a function key region at the border frame.

As shown in FIG. 4, after the border frame 11 is formed, the processing module 60 provides a function key region 30 at the border frame 11. The function key region 30 provides the function such as to restore the resolution so that the user can restore the resolution of the displayed picture 200a to its original resolution via the operation of the function key region 30. However, the number and function of the function key region 30 is not so limited. For example, the function key region 30 may also provide the function a Home button.

Lastly, step S107 is performed to remove the function key region and the border frame to restore the resolution of the central display region.

As shown in FIG. 3 and FIG. 4, according to the embodiment of the invention, if the user no longer holds the border frame 11 by hand, he or she can operate the function of restoring the resolution provided by the function key region 30 to restore the resolution of the displayed picture 200a to the resolution of the displayed picture 200 as shown in FIG. 3 to remove the function key region 30 and the border frame 11, so that the user can view the full-screen displayed picture 200 again.

With the screen resolution adjustment method of the invention, it is not necessary for the electronic device 100 to have a physical border frame. Therefore, the electronic device 100 may have a smaller volume. If the user needs to hold the electronic device 100 by hand, with the screen resolution adjustment method of the invention, the electronic device 100 can forma border frame 11 and a function key region 30 on the touch screen 1 temporarily for the user to hold and operate the electronic device 100. Furthermore, the user can adjust the resolution of the displayed picture 200 freely by touching different positions of the edge region 20.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A screen resolution adjustment method for a touch screen of an electronic device, wherein the touch screen includes a central display region and an edge region, the screen resolution adjustment method comprising the steps of:
receiving a touch signal on the touch screen;
judging whether the touch signal corresponds to a touch at the edge region; and
if the touch signal corresponds to the touch at the edge region, adjusting the resolution of a displayed picture displayed at the touch screen of the electronic device to form a border frame around the central display region.

2. The screen resolution adjustment method according to claim 1, further comprising the step of:
detecting a placed mode of the touch screen.

3. The screen resolution adjustment method according to claim 2, wherein the edge region includes a first edge region and a second edge region, and in the step of judging whether the touch signal corresponds to the touch at the edge region, it is judged whether the touch signal corresponds to the touch at the first edge region or the second edge region.

4. The screen resolution adjustment method according to claim 3, wherein if the touch signal corresponds to the touch at the edge region, in the step of adjusting the resolution of the displayed picture displayed at the touch screen of the electronic device to form the border frame around the central display region, the resolution of the displayed picture is adjusted to form the border frame according to the placed mode of the touch screen and the position of the touch signal.

5. The screen resolution adjustment method according to claim 1, further comprising the steps of:
judging whether the touch signal is lasted for more than a specific time period; and
in the step of adjusting the resolution of a displayed picture displayed at the touch screen of the electronic device to form the border frame around the central display region, the resolution of the displayed picture is adjusted to form the border frame if the touch signal corresponds to the touch at the edge region and is lasted for more than the specific time period.

6. The screen resolution adjustment method according to claim 4, further comprising the steps of:
providing a function key region at the border frame.

7. The screen resolution adjustment method according to claim 4, further comprising the steps of:
removing the function key region and the border frame and restoring the resolution of the displayed picture.

8. The screen resolution adjustment method according to claim 6, wherein the specific time period is between 1 to 3 seconds.

9. The screen resolution adjustment method according to claim 8, wherein a height of the edge region is between 1.5 to 2.5 centimeters.

10. An electronic device, comprising:
a touch screen including a central display region and an edge region;
a sensing module for sensing a touch signal;
a judgment module for judging whether the touch signal corresponds to a touch at the edge region; and
a processing module electronically connected with the touch screen, the sensing module and the judgment module, wherein when the sensing module receives the touch module and the judgment module judges that the touch signal corresponds to the touch at the edge region, the processing module adjusts the resolution of a displayed picture displayed at the touch screen to form a border frame around the central display region.

11. The electronic device according to claim 10, wherein the judgment module judges whether the touch signal is lasted for more than a specific time, and if the judgment module judges that the touch signal corresponds to the touch at the edge region and is lasted for more than a specific time, the processing module adjusts the resolution of the displayed picture.

12. The electronic device according to claim 11, wherein the edge region includes a first edge region and a second edge region, the judgment module judges whether the touch signal corresponds to the touch at the first edge region or the second edge region, and the processing module adjusts the resolution of the displayed picture according to the judgment of the judgment module.

13. The electronic device according to claim 12, wherein when the sensing module receives the touch signal and the judgment module judges that the touch signal corresponds to the touch at the edge region, the processing module controls the central display region to provide a function key region, the function key region is at the border frame.

14. The electronic device according to claim 13, wherein the specific time period is between 1 to 3 seconds.

15. The electronic device according to claim 14, wherein a height of the edge region is between 1.5 to 2.5 centimeters.
